(19) United States
(12) Patent Application Publication
(10) Pub. No.: US 2026/0148957 A1
(43) Pub. Date: May 28, 2026

(54) DRY ELECTRODE FILM FORMING SYSTEM

(71) Applicant: INDUSTRIAL TECHNOLOGY RESEARCH INSTITUTE, Hsinchu (TW)

(72) Inventors: Ko-Chieh CHAO, Taipei City (TW); Wen-Chin CHENG, Hsinchu City (TW); Ying-Fang CHANG, Hsinchu City (TW); Ming-Hau TSAI, Keelung City (TW); Yi-Wei LIN, Taichung City (TW)

(73) Assignee: INDUSTRIAL TECHNOLOGY RESEARCH INSTITUTE, Hsinchu (TW)

(21) Appl. No.: 18/962,513

(22) Filed: Nov. 27, 2024

(51) Int. Cl. H01M 4/04

(52) U.S. Cl. CPC H01M 4/0435; H01M 4/0402

(57) ABSTRACT

A dry electrode film forming system includes a quantitative feeding device, a powder uniformly delivering device and a rolling device. The quantitative feeding device has a powder inlet and a supply outlet, the powder inlet is configured for powder to be input therein, and the supply outlet outputs the powder. The powder uniformly delivering device has a receiving portion, a delivering channel and a powder outlet, the receiving portion corresponds to the supply outlet for receiving the powder from supply outlet, the delivering channel is connected to the receiving portion and the powder outlet, a width of the delivering channel gradually increases along a direction from the receiving portion towards the powder outlet for uniformly distributing and delivering the powder to the powder outlet. The rolling device corresponds to the powder outlet and is configured for rolling the powder from the powder outlet to a film.

### TECHNICAL FIELD

The disclosure relates to a film forming system, more particularly to a dry electrode film forming system.

### BACKGROUND

In order to avoid the problem of increased energy consumption caused by using toxic solvents and drying and recycling solvents in the wet processes for producing electrodes, a dry process has been developed that mainly uses a rolling method to produce electrodes. However, the current issue in the supply of material is that dry electrode powder is not a fluid and is unable to be compressed. If too much powder is supplied per unit time, in addition to affecting the film formation, it will also increase the electrode film's density excessively, which makes the electrode film unable to be wet by the electrolyte. If too little powder is supplied per unit time, the battery capacity will be insufficient. If the powder is not uniformly supplied, it may lead to inconsistent performance of the produced electrodes. Therefore, how to uniformly supply powder with the constant amount is one of topics in this field.

### SUMMARY

The disclosure provides a dry electrode film forming system which can uniformly provide the powder with the constant amount for producing a desired electrode.

One embodiment of the disclosure provides a dry electrode film forming system. The dry electrode film forming system includes a quantitative feeding device, a powder uniformly delivering device and a rolling device. The quantitative feeding device has a powder inlet and a supply outlet, the powder inlet is configured for powder to be input therein, and the supply outlet is configured to output the powder. The powder uniformly delivering device has a receiving portion, a delivering channel and a powder outlet, the receiving portion corresponds to the supply outlet for receiving the powder output from supply outlet, the delivering channel is connected to the receiving portion and the powder outlet, a width of the delivering channel gradually increases along a direction from the receiving portion towards the powder outlet for uniformly distributing and delivering the powder to the powder outlet, such that the powder outlet uniformly outputs the powder with a constant amount. The rolling device corresponds to the powder outlet and is configured for rolling the powder from the powder outlet to a film.

According to the dry electrode film forming system as discussed in the above embodiment, the quantitative feeding device provides the powder with a constant amount to the receiving portion of the powder uniformly delivering device, and the width of the delivering channel of the powder uniformly delivering device gradually increase along the direction from the receiving portion towards the powder outlet for uniformly contributing and delivering the powder to the powder outlet, which enables the powder outlet of the powder uniformly delivering device uniformly outputs the powder with the constant amount, such that the rolling device can roll an electrode with the desired specification.

### BRIEF DESCRIPTION OF THE DRAWINGS

The present disclosure will become better understood from the detailed description given herein below and the accompanying drawings which are given by way of illustration only and thus are not intending to limit the present disclosure and wherein:

FIG. 1 is a perspective view of a dry electrode film forming system according to a first embodiment of the disclosure;

FIG. 2 is a cross-sectional view of a quantitative feeding device in FIG. 1;

FIG. 3 is a perspective view of a uniformly distributing mold of a powder uniformly delivering device in FIG. 1;

FIG. 4 is a bottom view of the uniformly distributing mold in FIG. 3;

FIG. 5 is a cross-sectional view of the uniformly distributing mold in FIG. 4 taken along a line 5-5;

FIG. 6 is a cross-sectional view of the uniformly distributing mold in FIG. 4 taken along a line 6-6;

FIG. 7 shows an operation of the dry electrode film forming system in FIG. 1;

FIG. 8 is a perspective view of a dry electrode film forming system according to a second embodiment of the disclosure;

FIG. 9 is a perspective view of a dry electrode film forming system according to a third embodiment of the disclosure;

FIG. 10 is a perspective view of a powder uniformly delivering device in FIG. 9;

FIG. 11 is a schematic view of the powder uniformly delivering device in FIG. 10; and

FIG. 12 is a cross-sectional view of the powder uniformly delivering device in FIG. 10.

### DETAILED DESCRIPTION

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

In addition, the terms used in the present disclosure, such as technical and scientific terms, have its own meanings and can be comprehended by those skilled in the art, unless the terms are additionally defined in the present disclosure. That is, the terms used in the following paragraphs should be read on the meaning commonly used in the related fields and will not be overly explained, unless the terms have a specific meaning in the present disclosure.

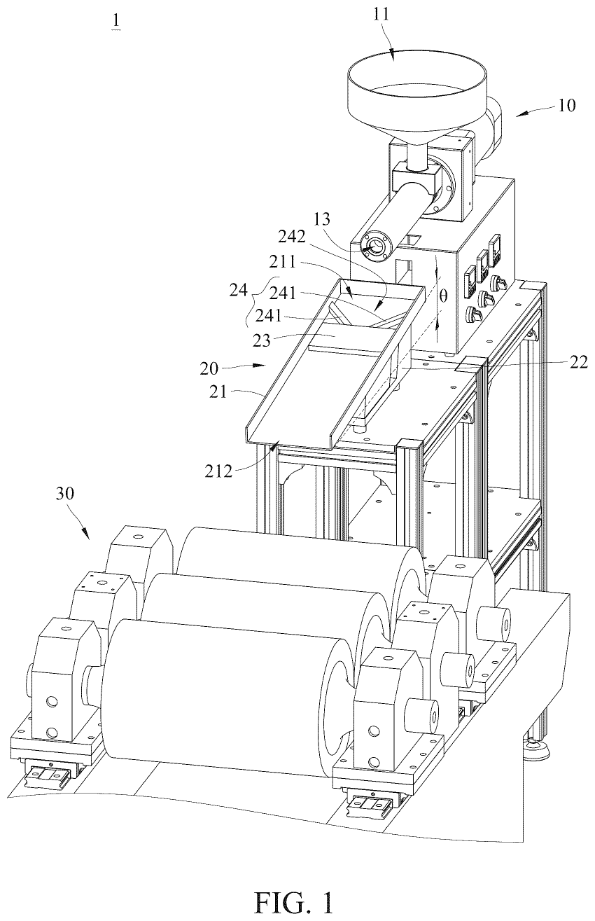

Referring to FIG. 1, FIG. 1 is a perspective view of a dry electrode film forming system according to a first embodiment of the disclosure.

In this embodiment, the dry electrode film forming system 1 includes a quantitative feeding device 10, a powder uniformly delivering device 20 and a rolling device 30, where the powder uniformly delivering device 20 is correspondingly disposed between the quantitative feeding device 10 and the rolling device 30.

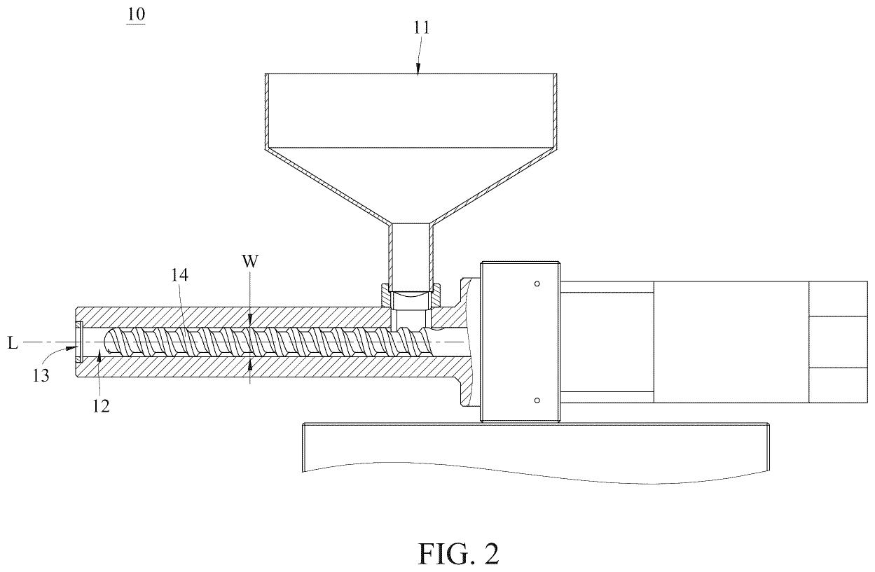

Then, referring to FIGS. 1 and 2, FIG. 2 is a cross-sectional view of a quantitative feeding device in FIG. 1.

The quantitative feeding device 10 is an extruder including a screw rod 14. The quantitative feeding device 10 has a powder inlet 11, an extrusion channel 12 and a supply outlet 13, and the powder inlet 11 and the supply outlet 13 respectively communicate with the extrusion channel 12. The powder inlet 11 is configured for powder to be input therein. The screw rod 14 can be driven by, for example but not limited to, a motor (not shown), and the screw rod 14 is rotatably located in the extrusion channel 12 for delivering the powder from powder inlet 11 towards the supply outlet 13. The screw rod 14, for example, has a uniform outer diameter along a long axis L thereof, which can prevent the pressure in the extrusion channel 12 from being too large to cause difference substances in the powder to separate from each other or cause the powder to be stuck in the extrusion channel 12. During the rotation of the screw rod 14, the screw rod 14 can deliver the powder from the powder inlet 11 to the supply outlet 13 through the extrusion channel 12, thereby outputting the powder from the supply outlet 13. The supply outlet 13 corresponds to the powder uniformly delivering device 20 for outputting the powder to the powder uniformly delivering device 20.

Then, referring to FIGS. 1 to 3, FIG. 3 is a perspective view of a uniformly distributing mold of a powder uniformly delivering device in FIG. 1.

The powder uniformly delivering device 20, for example, includes a tray 21, a vibration generator 22, a uniformly distributing mold 23 and a guide component 24. The tray 21 is disposed on the vibration generator 22, and an inclination angle θ of the tray 21 is greater than 0 degree and smaller than or equal to 10 degrees, such 5 degrees. The vibration generator 22 is, for example but not limited to, a linear vibrator, which can vibrate the tray 21 up and down. The tray 21 has a receiving portion 211 and a powder outlet 212, and the receiving portion 211 and the powder outlet 212 are located at two opposite ends of the tray 21. The receiving portion 211 corresponds to the supply outlet 13 for receiving the powder output from the supply outlet 13. The powder outlet 212 corresponds to the rolling device 30 and is configured to output the powder to the rolling device 30.

The uniformly distributing mold 23 is, for example, a rectangular mold. The uniformly distributing mold 23 may have a first end surface 231, a second end surface 232, two side surfaces 233 and a contact surface 234. The first end surface 231, the second end surface 232 and the side surfaces 233 are respectively located at difference sides of the uniformly distributing mold 23, and the first end surface 231 and the second end surface 232 are located opposite to each other, and the side surfaces 233 are located opposite to each other. Difference sides of the contact surface 234 are respectively connected to the first end surface 231, the second end surface 232 and the side surfaces 233. The uniformly distributing mold 23 is disposed on the tray 21, such that the contact surface 234 is in contact with the tray 21, and the first end surface 231 and the second end surface 232 respectively face the receiving portion 211 and the powder outlet 212; that is, the uniformly distributing mold 23 is located between the receiving portion 211 and the powder outlet 212.

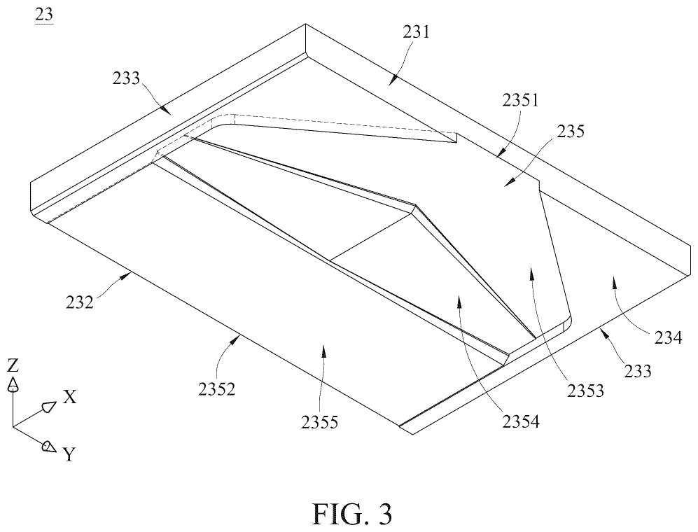

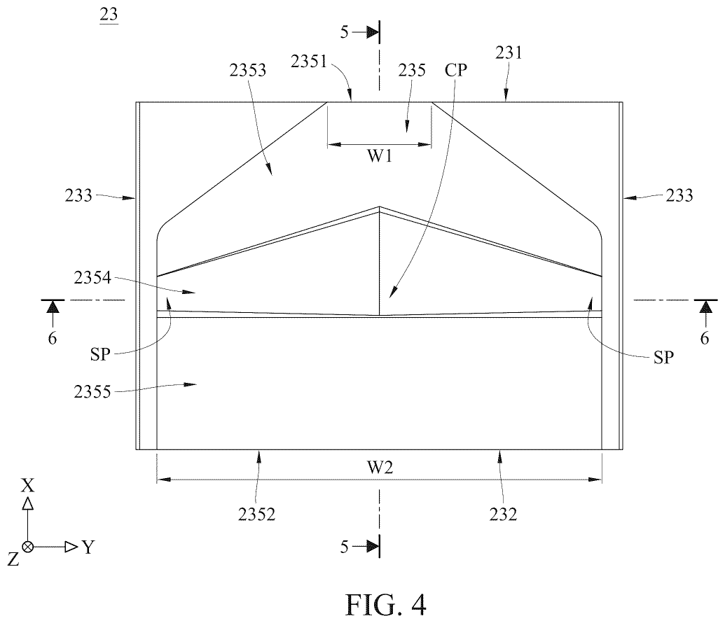

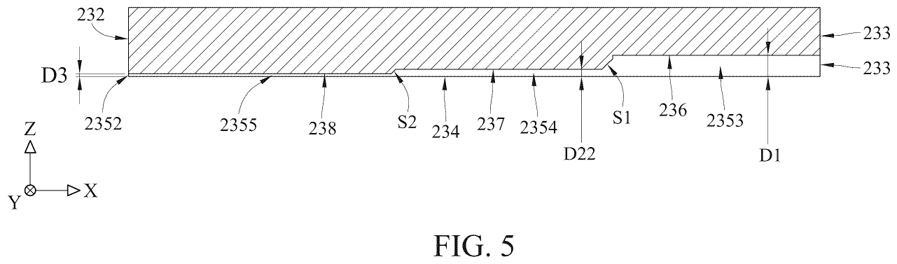

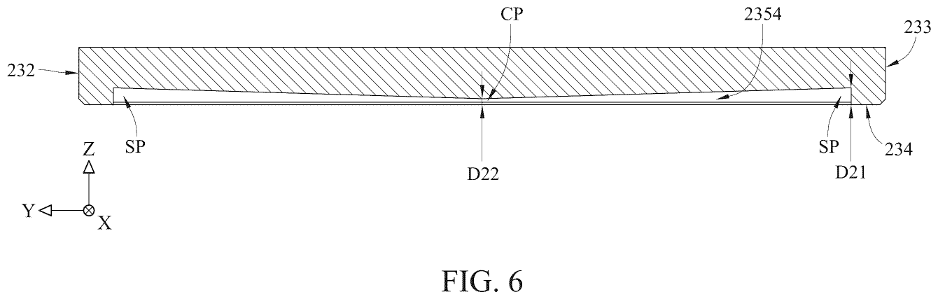

Then, referring to FIGS. 3 to 6, FIG. 4 is a bottom view of the uniformly distributing mold in FIG. 3, FIG. 5 is a cross-sectional view of the uniformly distributing mold in FIG. 4 taken along a line 5-5, and FIG. 6 is a cross-sectional view of the uniformly distributing mold in FIG. 4 taken along a line 6-6.

The uniformly distributing mold 23 further has a delivering channel 235, and the delivering channel 235 is recessed from the contact surface 234. An inlet 2351 and an outlet 2352 of the delivering channel 235 are respectively located at the first end surface 231 and the second end surface 232, and a width W1 of the inlet 2351 is smaller than a width W2 of the outlet 2352.

The delivering channel 235 has a first delivering portion 2353, a second delivering portion 2354 and a third delivering portion 2355. The first delivering portion 2353, the second delivering portion 2354 and the third delivering portion 2355 are sequentially arranged along a direction from the inlet 2351 towards the outlet 2352. A depth D1 of the first delivering portion 2353 is greater than a maximum depth D21 of the second delivering portion 2354, and a minimum depth D22 of the second delivering portion 2354 is greater than a depth D3 of the third delivering portion 2355. For example, the depth D1 of the first delivering portion 2353 is about 3 mm, the maximum depth D21 of the second delivering portion 2354 is about 2.869 mm, the minimum depth D22 of the second delivering portion 2354 is about 1 mm, and the depth D3 of the third delivering portion 2355 is about 0.35 mm.

In this embodiment, the uniformly distributing mold 23 may further have a first inner bottom surface 236, a second inner bottom surface 237, a third inner bottom surface 238, a first inclined guide surface S1 and a second inclined guide surface S2. The first inner bottom surface 236, the second inner bottom surface 237 and the third inner bottom surface 238 are respectively located at bottoms of the first delivering portion 2353, the second delivering portion 2354 and the third delivering portion 2355 of the delivering channel 235, the first inner bottom surface 236 and the second inner bottom surface 237 are connected to each other via the first inclined guide surface S1, and the second inner bottom surface 237 and the third inner bottom surface 238 are connected to each other via the second inclined guide surface S2. The first inclined guide surface S1 can help the powder to smoothly move from the first delivering portion 2353 to the second delivering portion 2354, and the second inclined guide surface S2 can help the powder to smoothly move from the second delivering portion 2354 to the third delivering portion 2355.

Note that the first inclined guide surface S1 and the second inclined guide surface S2 are optional structures. In some other embodiments, the inclined surfaces may be replaced by vertical surfaces when the movement of the powder is not adversely affected by such vertical surfaces. In other words, the first inner bottom surface and the second inner bottom surface may be connected to each other via the vertical surface, and the second inner bottom surface and the third inner bottom surface may be connected to each other via the vertical surface.

In this embodiment, a width of the first delivering portion 2353 gradually increases along the direction from the inlet 2351 towards the outlet 2352. In addition, a depth of the second delivering portion 2354 gradually increases along two directions towards the two side surfaces 233. For example, the second delivering portion 2354 has a central part CP and two side parts SP, the two side parts SP are respectively located closer to the two side surfaces 233 than the central part CP. A ratio of a maximum depth D21 of each of the side parts SP (i.e., the maximum depth D21 of the second delivering portion 2354) to a minimum depth D22 of the central part CP (i.e., the minimum depth D22 of the second delivering portion 2354) is, for example, greater than or equal to 1.5 and smaller than or equal to 5. For example, the maximum depths D21 of the side parts SP of the second delivering portion 2354 are about 2.869 mm, the minimum depth D22 of the central part CP of the second delivering portion 2354 is about 1 mm, and the aforementioned ratio is about 2.87.

As shown in FIG. 1, the guide component 24 is disposed on the receiving portion 211 of the tray 21, and the guide component 24 corresponds to the inlet 2351 of the delivering channel 235. The guide component 24, for example, includes two guide portions 241, the two guide portions 241 are spaced apart from each other so as to form a guide channel 242, and a width of the guide channel 242 gradually decreases along a direction towards the inlet 2351 of the delivering channel 235 for gathering and guiding the powder to the inlet 2351 of the delivering channel 235 of the uniformly distributing mold 23. Note that the guide component 24 is an optional component and may be omitted in some other embodiments.

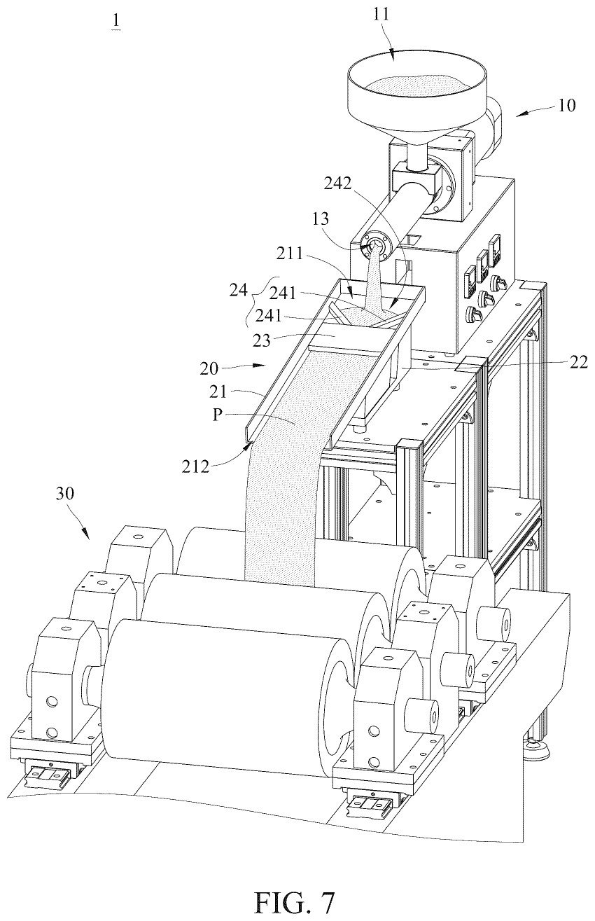

Then, the following paragraph will introduce the operation of the dry electrode film forming system 1. Referring to FIG. 7, FIG. 7 shows an operation of the dry electrode film forming system in FIG. 1.

Firstly, the powder P is poured into the quantitative feeding device 10 from the powder inlet 11 of the quantitative feeding device 10, and then the screw rod 14 in the extrusion channel 12 of the quantitative feeding device 10 delivers the powder P to the supply outlet 13 (e.g., shown in FIG. 2), such that the powder P drops on the receiving portion 211 of the tray 21 from the supply outlet 13. Next, the powder P is moved from the receiving portion 211 towards the powder outlet 212 of the tray 21 through the uniformly distributing mold 23 by the inclination of the tray 21 and the vibration of the tray 21 caused by the vibration generator 22. Next, the powder P drops on the rolling device 30 from the powder outlet 212, and the rolling device 30 rolls the powder P to a film-shaped electrode.

In this embodiment, the quantitative feeding device 10 provides the powder with a constant amount to the receiving portion 211 of the powder uniformly delivering device 20, and the width of the delivering channel 235 of the powder uniformly delivering device 20 gradually increase along the direction from the receiving portion 211 towards the powder outlet 212 for uniformly contributing and delivering the powder P to the powder outlet 212, which enables the powder outlet 212 of the powder uniformly delivering device 20 uniformly outputs the powder P with the constant amount, such that the rolling device 30 can roll an electrode with the desired specification.

In this embodiment, the delivering channel 235 has the first delivering portion 2353, the second delivering portion 2354 and the third delivering portion 2355 sequentially arranged along the direction from the inlet 2351 towards the outlet 2352, the depth D1 of first delivering portion 2353 is greater than the maximum depth D21 of the second delivering portion 2354, and the minimum depth D22 of the second delivering portion 2354 is greater than the depth D3 of the third delivering portion 2355, which can further help the powder P to uniformly move towards the powder outlet 212 with the constant amount after passing through the delivering channel 235.

Moreover, the depth of the second delivering portion 2354 gradually increases along the two directions towards the side surfaces 233, and the ratio of the maximum depth D21 of each of the side parts SP of the second delivering portion 2354 to the minimum depth D22 of the central part CP is, for example, greater than or equal to 1.5 and smaller than or equal to 5, which can help the powder P to spread outwards to two opposite sides for further enabling the powder P to uniformly move towards the powder outlet 212 with the constant amount after passing through the delivering channel 235.

Note that the depth of the second delivering portion 2354 is not restricted to be gradually increasing along the two directions towards the side surfaces 233. In some other embodiments, the depth of the second delivering portion may be maintained uniformly along the two directions towards the side surfaces.

In addition, the delivering channel 235 is not restricted to having the first delivering portion 2353, the second delivering portion 2354 and the third delivering portion 2355. The quantity of the delivering portion of the delivering channel may be modified according to actual requirements. For example, in one embodiment, the delivering channel may be further provided with a fourth delivering portion, or the third delivering portion may be omitted, even the second delivering portion may be further omitted.

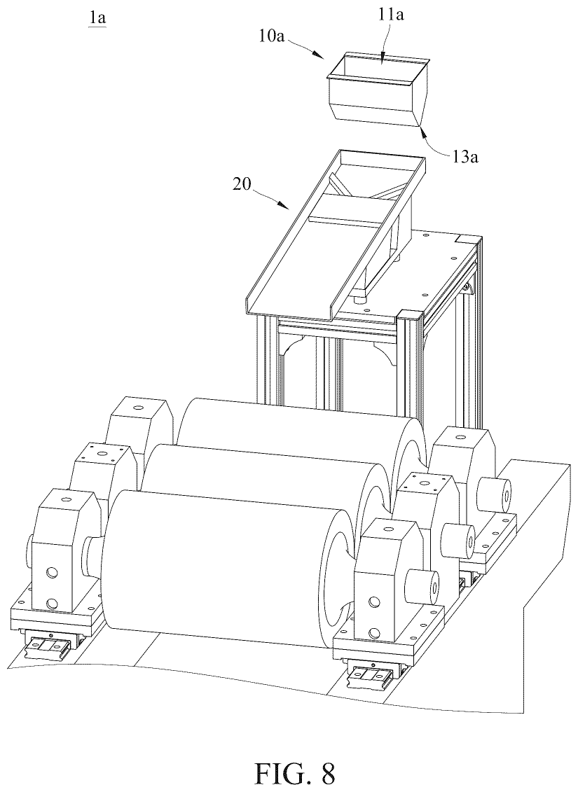

Note that the powder P is not restricted to being delivered to the powder uniformly delivering device 20 by the extruder including the screw rod 14. For example, referring to FIG. 8, FIG. 8 is a perspective view of a dry electrode film forming system according to a second embodiment of the disclosure.

The dry electrode film forming system 1a of this embodiment is similar to the dry electrode film forming system 1 of the previous embodiment, the main difference between them is the type of the quantitative feeding device, and thus the following paragraphs mainly introduce a quantitative feeding device 10a of this embodiment while the same parts between them will not be repeatedly introduced hereinafter.

In this embodiment, the quantitative feeding device 10a is, for example, a dynamic weigher. When the amount of the powder poured into the quantitative feeding device 10a from a powder inlet 11a of the quantitative feeding device 10a accumulates to a predetermined amount, a supply outlet 13a of the quantitative feeding device 10a will be opened, such that the powder drops on the powder uniformly delivering device 20.

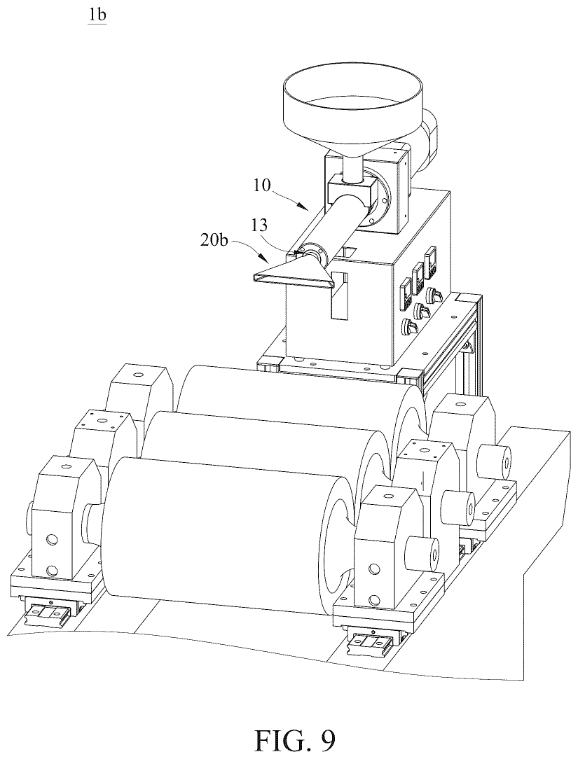

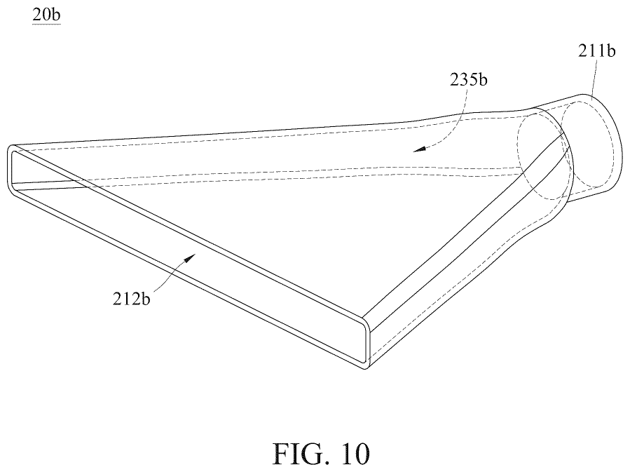

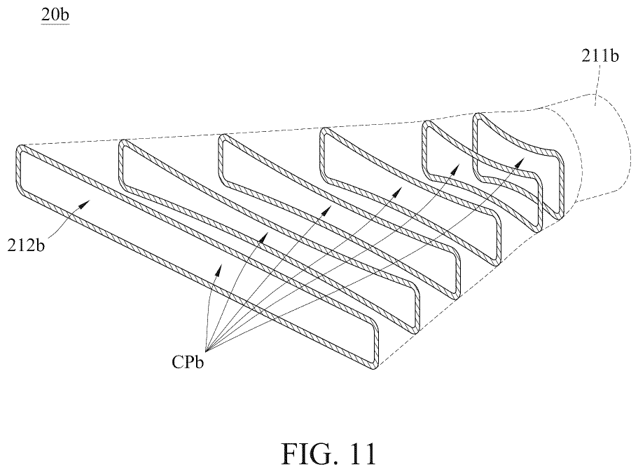

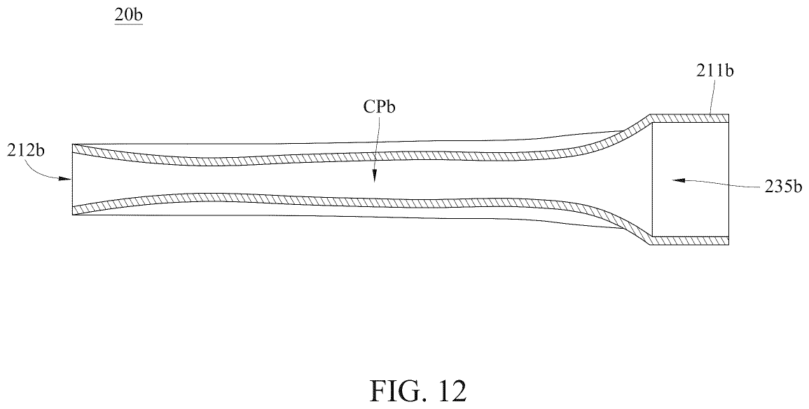

Note that the powder is not restricted to being delivered to the rolling device 30 by the powder uniformly delivering device 20. Referring to FIGS. 9 to 12, FIG. 9 is a perspective view of a dry electrode film forming system according to a third embodiment of the disclosure, FIG. 10 is a perspective view of a powder uniformly delivering device in FIG. 9, FIG. 11 is a schematic view of the powder uniformly delivering device in FIG. 10, and FIG. 12 is a cross-sectional view of the powder uniformly delivering device in FIG. 10.

The dry electrode film forming system 1b of this embodiment is similar to the dry electrode film forming system 1 of the previous embodiment, the main difference between them is the type of the powder uniformly delivering device, and thus the following paragraphs mainly introduce a powder uniformly delivering device 20b of this embodiment while the same parts between them will not be repeatedly introduced hereinafter.

In this embodiment, the powder uniformly delivering device 20b is, for example, a flat die, and a receiving portion 211b of the powder uniformly delivering device 20b is directly assembled with the supply outlet 13 of the quantitative feeding device 10. A width of a delivering channel 235b of the powder uniformly delivering device 20b gradually increases along a direction from the receiving portion 211b towards a powder outlet 212b, and a height of a central part CPb of the delivering channel 235b gradually decreases and then increases along the direction from the receiving portion 211b towards the powder outlet 212b. Therefore, the powder uniformly delivering device 20b can uniformly deliver the powder with the constant amount.

According to the dry electrode film forming system as discussed in the above embodiment, the quantitative feeding device provides the powder with a constant amount to the receiving portion of the powder uniformly delivering device, and the width of the delivering channel of the powder uniformly delivering device gradually increase along the direction from the receiving portion towards the powder outlet for uniformly contributing and delivering the powder to the powder outlet, which enables the powder outlet of the powder uniformly delivering device uniformly outputs the powder with the constant amount, such that the rolling device can roll an electrode with the desired specification.

In addition, the delivering channel has the first delivering portion, the second delivering portion and the third delivering portion sequentially arranged along the direction from the inlet towards the outlet, the depth of first delivering portion is greater than the maximum depth of the second delivering portion, and the minimum depth of the second delivering portion is greater than the depth of the third delivering portion, which can further help the powder to uniformly move towards the powder outlet with the constant amount after passing through the delivering channel.

Moreover, the depth of the second delivering portion gradually increases along the two directions towards the side surfaces, and the ratio of the maximum depth of each of the side parts of the second delivering portion to the minimum depth of the central part is, for example, greater than or equal to 1.5 and smaller than or equal to 5, which can help the powder to spread outwards to two opposite sides for further enabling the powder to uniformly move towards the powder outlet with the constant amount after passing through the delivering channel.

It will be apparent to those skilled in the art that various modifications and variations can be made to the present disclosure. It is intended that the specification and examples be considered as exemplary embodiments only, with a scope of the disclosure being indicated by the following claims and their equivalents.

What is claimed is:

1. A dry electrode film forming system, comprising:
a quantitative feeding device, having a powder inlet and a supply outlet, wherein the powder inlet is configured for powder to be input therein, and the supply outlet is configured to output the powder;
a powder uniformly delivering device, having a receiving portion, a delivering channel and a powder outlet, wherein the receiving portion corresponds to the supply outlet for receiving the powder output from supply outlet, the delivering channel is connected to the receiving portion and the powder outlet, a width of the delivering channel gradually increases along a direction from the receiving portion towards the powder outlet for uniformly distributing and delivering the powder to the powder outlet, such that the powder outlet uniformly outputs the powder with a constant amount; and
a rolling device, corresponding to the powder outlet and configured for rolling the powder from the powder outlet to a film.

2. The dry electrode film forming system according to claim 1, wherein the quantitative feeding device is an extruder comprising a screw rod.

3. The dry electrode film forming system according to claim 2, wherein the screw rod has a uniform outer diameter along a long axis thereof.

4. The dry electrode film forming system according to claim 1, wherein the quantitative feeding device is a dynamic weigher.

5. The dry electrode film forming system according to claim 1, wherein the powder uniformly delivering device comprises a tray, a vibration generator and a uniformly distributing mold, the tray is disposed on the vibration generator, the uniformly distributing mold is disposed on the tray, the tray has the receiving portion and the powder outlet, the receiving portion and the powder outlet are located at two opposite ends of the tray, and the uniformly distributing mold has the delivering channel.

6. The dry electrode film forming system according to claim 5, wherein the uniformly distributing mold further has a first end surface, a second end surface and a contact surface, the first end surface and the second end surface are located opposite to each other and respectively face the receiving portion and the powder outlet, the contact surface is in contact with the tray, the delivering channel is recessed from the contact surface, an inlet and an outlet of the delivering channel are respectively located at the first end surface and the second end surface, and an width of the inlet of the delivering channel is smaller than a width of the outlet of the delivering channel.

7. The dry electrode film forming system according to claim 6, wherein the delivering channel further has a first delivering portion, a second delivering portion and a third delivering portion, the first delivering portion, the second delivering portion and the third delivering portion are sequentially arranged along a direction from the inlet towards the outlet of the delivering channel, a depth of the first delivering portion is greater than a depth of the second delivering portion, and the depth of the second delivering portion is greater than a depth of the third delivering portion.

8. The dry electrode film forming system according to claim 7, wherein a width of the first delivering portion gradually increases along the direction from the inlet towards the outlet of the delivering channel.

9. The dry electrode film forming system according to claim 7, wherein the uniformly distributing mold further has two side surfaces located opposite to each other, the two side surfaces are connected to the first end surface and the second end surface, the delivering channel is located between the two side surfaces, and the depth of the second delivering portion gradually increases along two directions towards the two side surfaces.

10. The dry electrode film forming system according to claim 9, wherein the second delivering portion has a central part and two side parts, the two side parts are respectively located closer to the two side surfaces than the central part, and a ratio of a maximum depth of each of the two side parts to a minimum depth of the central part is greater than or equal to 1.5 and smaller than or equal to 5.

11. The dry electrode film forming system according to claim 7, wherein the uniformly distributing mold further has a first inner bottom surface, a second inner bottom surface, a third inner bottom surface, a first inclined guide surface and a second inclined guide surface, the first inner bottom surface, the second inner bottom surface and the third inner bottom surface are respectively located at bottoms of the first delivering portion, the second delivering portion and the third delivering portion of the delivering channel, the first inner bottom surface and the second inner bottom surface are connected to each other via the first inclined guide surface, and the second inner bottom surface and the third inner bottom surface are connected to each other via the second inclined guide surface.

12. The dry electrode film forming system according to claim 6, wherein the powder uniformly delivering device further comprises a guide component, the guide component is disposed on the tray and is located at the receiving portion, and the guide component corresponds to the inlet of the delivering channel.

13. The dry electrode film forming system according to claim 12, wherein the guide component comprises two guide portions, the two guide portions are spaced apart from each other and form a guide channel, and a width of the guide channel gradually decreases along a direction towards the inlet of the delivering channel.

14. The dry electrode film forming system according to claim 5, wherein an inclination angle of the tray is greater than 0 degrees and smaller than or equal to 10 degrees.

15. The dry electrode film forming system according to claim 1, wherein the powder uniformly delivering device is a flat die, and the receiving portion of the powder uniformly delivering device is directly assembled with the supply outlet of the quantitative feeding device.

16. The dry electrode film forming system according to claim 15, wherein a height of a central part of the delivering channel gradually decreases and then increases along the direction from the receiving portion towards the powder outlet.
